(19) United States
(12) Patent Application Publication
(10) Pub. No.: US 2026/0285629 A1
(43) Pub. Date: Sep. 24, 2026

(54) CONVEYING DEVICE, IMAGE FORMING APPARATUS, AND CURL CORRECTOR

(71) Applicant: Toshiaki Tobishima, Saitama (JP)

(72) Inventor: Toshiaki Tobishima, Saitama (JP)

(73) Assignee: ETRIA Co., Ltd., Kanagawa (JP)

(21) Appl. No.: 19/560,310

(22) Filed: Mar. 9, 2026

(30) Foreign Application Priority Data
Mar. 21, 2025 (JP) 2025-046577

(51) Int. Cl. B65H 7/06; B65H 5/06

(52) U.S. Cl. CPC B65H 7/06; B65H 5/062; B65H 2515/815; B65H 2801/06

(57) ABSTRACT

In a conveying device, the conveyor conveys the sheet rolled around a first curvature center through a conveyance path in a conveyance direction. The conveyor includes a first roller pair downstream of the sheet feeder and a second roller pair downstream of the first roller pair in the conveyance direction. The second roller pair includes a first roller and a second roller disposed to nip the sheet and having a second curvature center opposite to the first curvature center. The circuitry feeds the sheet from the first roller pair to the second roller pair until the sheet passes the second roller pair, and reversely feeds the sheet from the second roller pair toward the first roller pair, to slack a leading end of the sheet toward the second roller of the second roller pair to form a slack portion in the leading end to correct a curl of the sheet.

### CROSS-REFERENCE TO RELATED APPLICATIONS

This patent application is based on and claims priority pursuant to 35 U.S.C. § 119(a) to Japanese Patent Application No. 2025-046577, filed on Mar. 21, 2025, in the Japan Patent Office, the entire disclosure of which is hereby incorporated by reference herein.

### BACKGROUND

### Technical Field

The present disclosure relates to a conveying device, an image forming apparatus, and a curl corrector.

### Related Art

A conveying device has been developed, which includes a conveyor that conveys a sheet to a predetermined destination and a curl corrector to correct a curl of the sheet.

For example, a conveyance device is disclosed in which a branch path is formed midway along a sheet conveyance path in an image forming apparatus, and a curl corrector (a curl straightening device) is connected to the branch path.

The curl corrector of the conveying device includes a drive roller around which a film member is wound. When a sheet is inserted between the drive roller and the film member and the drive roller is rotated, the leading edge of the sheet is bent along the curved surface of the drive roller. In this conveying device, when correcting a curl at the leading edge of a sheet, the leading edge is guided from the main sheet conveyance path into a branch path. A drive roller of the curl corrector connected to the branch path then operates to straighten the curl. The drive roller member is then driven in the reverse direction to return the sheet from the branch path to the sheet conveyance path. After that, the returned sheet is conveyed along the sheet conveyance path to a predetermined destination.

However, in such a typical conveying device, it might take time to convey the curl-corrected sheet to a predetermined destination.

### SUMMARY

The present disclosure described herein provides a conveying device including a sheet feeder, a conveyor, and circuitry. The sheet feeder is used to load a sheet rolled around a first curvature center. The conveyor conveys the sheet fed from the sheet feeder through a conveyance path in a conveyance direction. The conveyor includes a first roller pair disposed downstream of the sheet feeder in the conveyance direction to convey a sheet in the conveyance direction; and a second roller pair disposed downstream of the first roller pair in the conveyance direction. The second roller pair includes a first roller and a second roller disposed opposite to the first roller via the conveyance path to form a nip to nip the sheet between the first roller and the second roller; and having a second curvature center opposite to the first curvature center at the nip. The circuitry is configured to feed the sheet from the first roller pair to the second roller pair until the sheet passes the second roller pair; reversely feed the sheet from the second roller pair toward the first roller pair, to slack a leading end of the sheet toward the second roller of the second roller pair to form a slack portion in the leading end to correct a curl of the sheet.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a perspective view of an inkjet recording apparatus;

FIG. 2 is a top view of a carriage of the inkjet recording apparatus in FIG. 1;

FIG. 3 is a diagram illustrating a configuration of the inkjet recording apparatus in FIG. 1;

FIG. 4 is a block diagram illustrating a control configuration of the ink jet recording apparatus in FIG. 1;

FIG. 5 is a diagram illustrating a curl generated in a sheet wound in a roll and stored in a sheet storage, and a curl for correcting the curl;

FIG. 6 is a diagram illustrating a curl correction process;

FIG. 7 is a flowchart of a process for placing a rolled sheet into a rolled-sheet storage and positioning the rolled sheet at a predetermined standby position;

FIG. 8 is a flowchart of a process for conveying a rolled sheet located at the standby position and correcting the curl of the rolled sheet;

FIGS. 9A to 9D are diagrams each illustrating a rolled sheet during the correction of a curl;

FIG. 10 is a flowchart of a process for forming an image on a rolled sheet with an image former and ejecting the sheet;

FIG. 11 is a diagram illustrating a configuration in which an outer conveyance guide is displaceable in a direction toward or away from a surface of a rolled sheet;

FIG. 12A is a diagram illustrating a wrap angle θ1 of the slack portion of the rolled sheet along the curved surface of the outer roller from the nip region of the registration roller pair; FIG. 12B is a diagram illustrating a wrap angle θ2 of the slack portion; and

FIG. 13 is a diagram illustrating an arrangement in which the slack portion enters a curl-correction state due to its own weight.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

According to one aspect of the present disclosure, the curl-corrected sheet can be conveyed to a predetermined destination in a shorter time.

In the following description, an embodiment applying the present disclosure to a conveying device in an inkjet recording apparatus as an image forming apparatus will be described.

The conveying device according to the present disclosure is not limited to the configuration and the method of the image forming apparatus, and may be applied to any apparatus that forms an image on a sheet. Thus, the present invention is also applicable to, for example, an electrophotographic image forming apparatus. Furthermore, the conveying device according to the present disclosure can also be applied to various apparatuses that use a device for conveying a sheet.

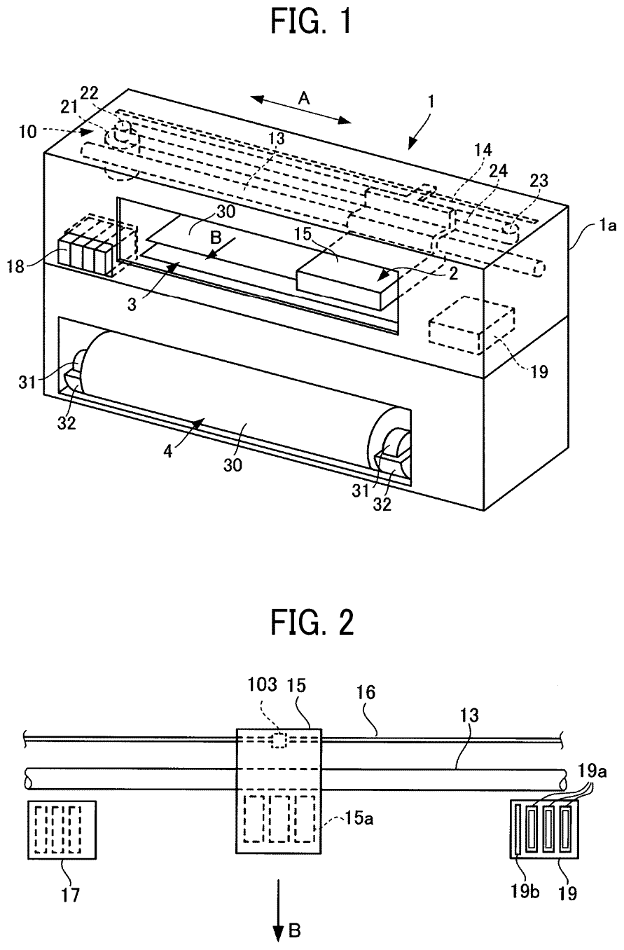

FIG. 1 is a perspective view of an inkjet recording apparatus 1.

FIG. 2 is a top view of a carriage of the inkjet recording apparatus 1 in FIG. 1.

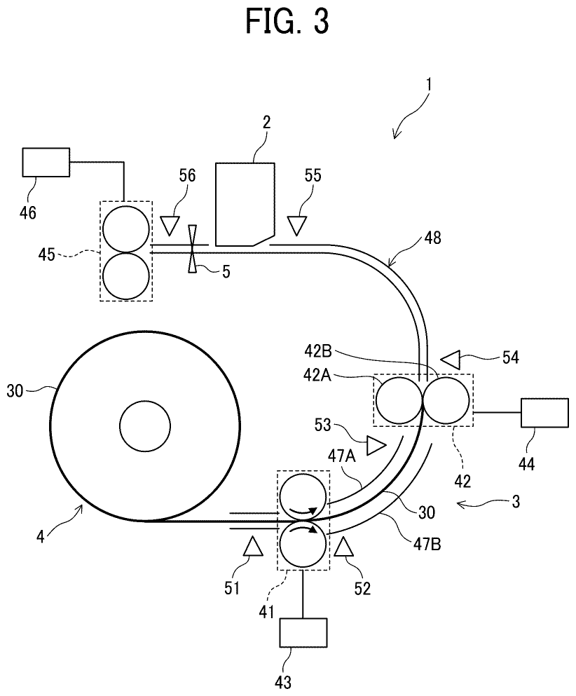

FIG. 3 is a perspective view of the inkjet recording apparatus 1.

The inkjet recording apparatus 1 is a serial inkjet recording apparatus. That is, while a recording head 15a mounted on a carriage 15 is scanned in a sheet-width direction, which is orthogonal to a sheet conveyance direction, ink that is liquid is discharged from the inkjet head to form an image on the sheet. After one or more scans are completed, the sheet is conveyed by a fixed amount, and the next image is formed.

The inkjet recording apparatus 1 includes an image former 2, a sheet conveyor 3, a rolled-sheet storage 4, and a sheet cutter 5, all of which are disposed inside an apparatus body 1a.

The image former 2 includes a guide rod 13, a guide rail 14, and the carriage 15. The guide rod 13 and the guide rail 14 are extended between a pair of side plates. The carriage 15 is slidably supported by the guide rod 13 and the guide rail 14 in a direction A in FIG. 1. The term “slide” as used herein means that the carriage 15 moves along the guide rod 13 and the guide rail 14 in the direction A while being in contact with the guide rod 13 and the guide rail 14.

The carriage 15 mounts recording heads 15a (see FIG. 2) including liquid discharge heads that discharge liquids (inks) of respective colors of black (K), yellow (Y), magenta (M), and cyan (C). Each recording head 15a includes a head tank as a single unit. The head tank supplies ink to each recording head 15a.

The carriage 15 is moved and scanned in a main scanning direction, that is, the sheet-width direction, indicated by arrow A in the figure, by a main scanner 10. Specifically, the carriage 15 is movable in the sheet-width direction between a carriage-home position and an idle-discharge position. The carriage-home position and the idle discharge position are spaced apart from each other in the sheet-width direction outside a maximum sheet-width region of the rolled sheet 30, on which an image can be recorded.

In the following description, the movement region of the carriage 15 in the sheet-width direction is referred to as a carriage movement region. That is, the idle-discharge position and the carriage-home position are provided at both ends of the carriage movement region. The idle-discharge position and the carriage-home position are disposed at respective retracted positions outside a cutter movement region described later so as to avoid contact with a cutter unit (e.g., the sheet cutter 5). The idle-discharge position and the carriage-home position are collectively referred to as a cutting standby position.

The main scanner 10 includes a carriage drive motor 21 disposed on one side in the sheet width direction, a drive pulley 22 rotationally driven by the carriage drive motor 21, a driven pulley 23 disposed on the other side in the sheet width direction, and a belt 24 wound around the drive pulley 22 and the driven pulley 23. The driven pulley 23 is externally tensioned by a tension spring. That is, tension is applied to the driven pulley 23 in a direction away from the drive pulley 22. A portion of the belt 24 is fixed and held by a belt fixing portion provided on a rear side of the carriage 15, so that the belt 24 pulls the carriage 15 in the sheet-width direction.

As illustrated in FIG. 2, an encoder sheet 16 is disposed along the sheet-width direction of the carriage 15 to detect the main-scanning position of the carriage 15. The main-scanning position of the carriage 15 is detected by reading the encoder sheet 16 with an encoder sensor 103 provided in the carriage 15.

As illustrated in FIGS. 1 and 2, in a recording region of a main-scanning region (the carriage movement region) of the carriage 15, the rolled sheet 30 is intermittently conveyed by the sheet conveyor 3 in the sheet conveyance direction orthogonal to the sheet-width direction. The sheet conveyance direction is indicated by arrow B in the figure.

A main cartridge 18 containing ink of respective colors to be supplied to the sub-tanks of the recording heads 15a is detachably mounted on the apparatus body 1a outside the carriage movement region in the sheet-width direction or at one end of the main-scanning region. As illustrated in FIG. 2, an idle-discharge receiver 17 is disposed adjacent to the idle-discharge position in the carriage movement region (on the left side in FIG. 2) to receive ink droplets discharged during an idle-discharge operation, in which ink droplets that do not contribute to image recording (e.g., printing) are discharged so as to discharge thickened ink having increased viscosity. Each recording head 15a is designed to perform idle discharge at the idle-discharge position when a predetermined condition is satisfied, to maintain and recover discharge performance.

Further, a capping position is provided adjacent to the carriage-home position in the carriage movement region (on the right side in FIG. 2), and a maintenance-and-recovery mechanism 19 for maintaining and recovering the recording heads 15a is disposed at the capping position. The maintenance-and-recovery mechanism 19 includes respective caps 19a for capping the nozzle faces of the recording heads 15a, a wiper blade 19b for wiping each nozzle face, a cap-and-wiper lifter for raising and lowering the respective caps 19a and the wiper blade 19b, and a suction device connected to the respective caps 19a to perform suction with the nozzle faces capped.

The rolled-sheet storage 4 serves as a sheet feeder, and the rolled sheet 30 is loaded in the rolled-sheet storage 4 as a sheet for image recording. However, a rolled sheet having a different size in the sheet-width direction can be set in the rolled-sheet storage 4. The rolled sheet 30 is accommodated in the rolled-sheet storage 4 by attaching flanges 31 to opposite ends of a paper core of the rolled sheet 30 and placing the flanges 31 on flange receivers 32. Support rollers are provided inside the flange receivers 32, and the support rollers contact outer circumferential surfaces of the flanges 31 to rotate the flanges 31 rotate, thus feeding the rolled sheet 30 to the sheet conveyance path.

As illustrated in FIG. 3, the sheet conveyor 3 includes a sheet feed roller pair 41 as a first conveyor, a registration roller pair 42 as a second conveyor, and drive motors 43 and 44 that drive the respective rollers. The drive motors 43 and 44 are controlled by a controller 50 of the apparatus body 1a. Further, in the sheet conveyance path of the sheet conveyor 3, an upstream sensor 51 of the sheet feed roller pair, a downstream sensor 52 of the sheet feed roller pair, an upstream sensor 53 of the registration roller pair, a downstream sensor 54 of the registration roller pair, an image-former sensor 55, and a sheet-eject sensor 56 are arranged.

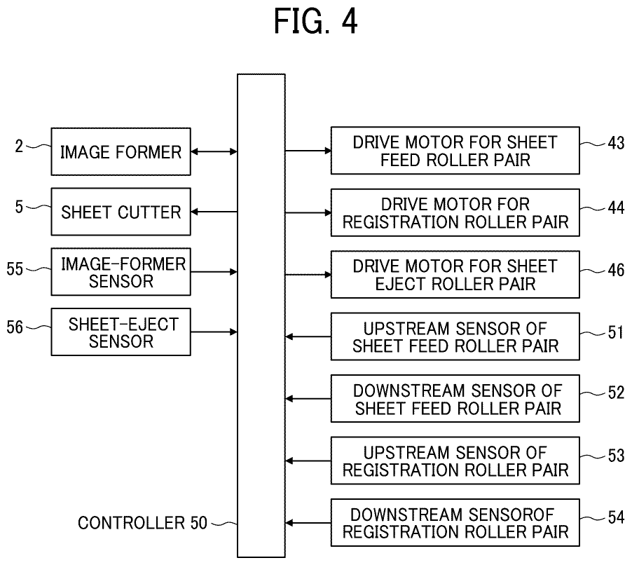

FIG. 4 is a block diagram illustrating a control configuration of the inkjet recording apparatus 1 in FIG. 1.

The detection results of the upstream sensor 51 of the sheet feed roller pair and the downstream sensor 52 of the sheet feed roller pair are sent to the controller 50, and are used for controlling an amount of sheet conveyance by the sheet feed roller pair 41. That is, the controller 50 controls the drive motor 43 of the sheet feed roller pair 41, based on detection results of the upstream sensor 51 and the downstream sensor 52 of the sheet feed roller pair, to control the amount of sheet conveyance by the sheet feed roller pair 41.

Detection results of the upstream sensor 53 and downstream sensor 54 of the registration roller pair are sent to the controller 50 and are used to control an amount of sheet conveyance by the registration roller pair 42. That is, the controller 50 controls the drive motor 44 that drives the registration roller pair 42, based on detection results of the upstream sensor 53 and the downstream sensor 54 of the registration roller pair, to control the amount of sheet conveyance by the registration roller pair 42.

Detection results from the image-former sensor 55 is sent to the controller 50 and are used for controlling the image former 2. Detection results from the sheet-eject sensor 56 are sent to the controller 50 and are used to control the sheet cutter 5 and the amount of sheet conveyance by the ejection roller pair 45.

The sheet feed roller pair 41 is disposed downstream of the rolled-sheet storage 4 in the conveyance direction, the rolled-sheet storage 4 accommodating the rolled sheet 30, which is a sheet roll formed by winding a sheet. The sheet feed roller pair 41 is rotationally driven by the driving force of the drive motor 43 to unwind the rolled sheet 30 accommodated in the rolled-sheet storage 4 and feed an unwound portion of the rolled sheet 30 (a sheet drawn-out portion) to the sheet conveyance path.

The rolled sheet 30 fed to the sheet conveying path is conveyed to the registration roller pair 42 while being guided by conveyance guides 47A and 47B arranged along the sheet conveying path so as to face the respective surfaces of the rolled sheet 30. The registration roller pair 42 is disposed upstream of the image former 2 in the conveyance direction. The registration roller pair 42 nips the rolled sheet 30 at a nip region (e.g., a registration nip) formed by two rollers 42A and 42B (a pair of nipping members, e.g., a first nip roller and a second nip roller) constituting the registration roller pair 42. The registration roller pair 42 is driven to rotate by a driving force of the drive motor 44, feeding the rolled sheet 30 nipped in the nip region toward the image former 2. The rolled sheet 30 fed by the registration roller pair 42 is guided by a conveyance guide 48 and fed to the image former 2.

The rolled sheet 30 fed into the image former 2 is conveyed to a recording region located below the recording heads 15a mounted on the carriage 15. When the rolled sheet 30 is conveyed to the recording region, the carriage 15 reciprocates in the sheet-width direction (main-scanning direction), and ink droplets are discharged from the recording heads 15a in accordance with image information. Then, while the rolled sheet 30 is intermittently conveyed in the sheet conveyance direction (sub-scanning direction) by driving the sheet feed roller pair 41 and the registration roller pair 42, ink droplets are repeatedly discharged from the recording heads 15a in accordance with the image information. As a result, a desired image corresponding to the image information is formed on the rolled sheet 30.

The rolled sheet 30 after image formation is cut to a predetermined length by the sheet cutter 5. The ejection roller pair 45 is disposed downstream of the sheet cutter 5 in the conveyance direction. The ejection roller pair 45 is rotated by a driving force from the drive motor 46 to eject the rolled sheet (cut sheet) cut by the sheet cutter 5 after image formation to an ejection tray.

A process for correcting the curl is described below.

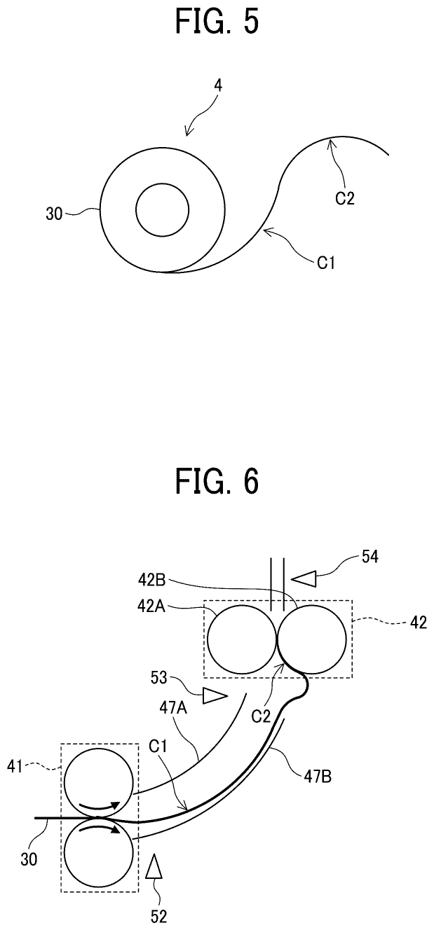

As illustrated in FIG. 5, the curl-correction process of the present embodiment corrects a curl C1 set in the rolled sheet 30 by imparting to the rolled sheet 30 a curl C2 having a curl direction opposite to that of the curl C1. The curl C1 is a curl memory caused by winding and bending and set while the rolled sheet 30 is wound in a roll shape and stored in the rolled-sheet storage 4. The curl direction refers to a direction or orientation in which the sheet curls.

A curl-correction process according to an embodiment of the present disclosure is applicable not only to correction of the curl C1 of the rolled sheet 30, but also to correction of curl set at any position and over any length. Accordingly, the curl-correction process is also applicable to, for example, correction of curl that has become set during conveyance of the rolled sheet 30 along the sheet conveyance path or while the rolled sheet 30 is stopped on the sheet conveyance path.

FIG. 6 is a diagram illustrating a curl correction process.

In the curl-correction process of the present embodiment, as illustrated in FIG. 6, a portion of the rolled sheet 30 located between the sheet feed roller pair 41 and the registration roller pair 42 is slackened. Then, the slack portion of the roll sheet is brought into a curl-correction state by being pressed, from the nip region of the registration roller pair 42, against and along the curved surface of the outer roller 42B, which is a curved-surface member constituting the registration roller pair 42.

The outer roller 42B has a curved surface (a roller outer circumferential surface) having a center of curvature located across the rolled sheet 30 from a center of curvature of the curl C1 set in the rolled sheet 30. Accordingly, by pressing the rolled sheet 30 against and along the curved surface of the outer roller 42B, the curl C2 having a curl direction opposite to the curl direction of the curl C1 set in the rolled sheet 30 can be imparted to the rolled sheet 30.

The following describes the control flow in the curl-correction process.

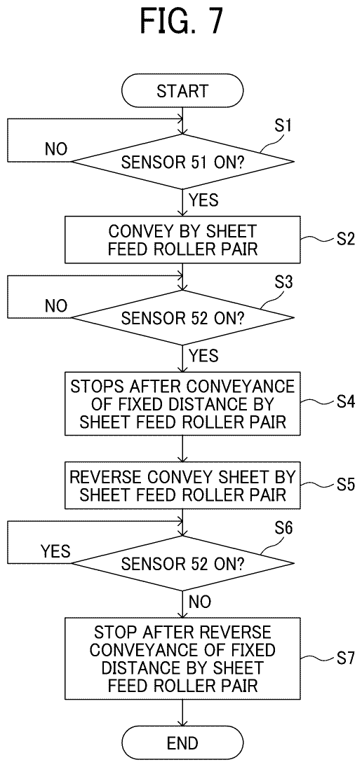

FIG. 7 is a flowchart of a process for placing a rolled sheet 30 into a rolled-sheet storage 4 and positioning the rolled sheet 30 at a predetermined standby position.

After setting the rolled sheet 30 in the rolled-sheet storage 4, the leading end of the rolled sheet 30 is inserted into the nip region of the sheet feed roller pair 41. At this time, the upstream sensor of the upstream sensor 51 turns ON upon detecting the rolled sheet 30 (Yes in S1).

In step S2, upon receiving an ON signal from the upstream sensor 51, the controller 50 drives the drive motor 43 to convey the rolled sheet 30 inserted into the nip region of the sheet feed roller pair 41 in a forward direction (a direction in which the rolled sheet 30 is sent toward the image former 2).

When the rolled sheet 30 is conveyed and a leading end of the rolled sheet 30 passes through a detection region of the downstream sensor 52, the downstream sensor 52 of the sheet feed roller pair turns ON (Yes in S3). In step S4, upon receiving an ON signal from the downstream sensor 52, the controller 50 causes the sheet feed roller pair 41 to convey the rolled sheet 30 in the forward direction by a fixed distance, and then stops the drive motor 43. In step S5, the controller 50 controls the drive motor 43 to drive the sheet feed roller pair 41 in a reverse direction opposite to the forward direction, conveying the rolled sheet 30 nipped in the nip region of the sheet feed roller pair 41 in the reverse direction.

When the leading end of the rolled sheet 30, which is conveyed in the reverse direction, passes through the detection region of the downstream sensor 52, the downstream sensor 52 turns OFF (No in S6).

In step S7, upon receiving an OFF signal from the downstream sensor 52, the controller 50 causes the sheet feed roller pair 41 to convey the rolled sheet 30 in the reverse direction by a fixed distance, and then stops the drive motor 43. A a result, the leading end of the rolled sheet 30 can be positioned at a predetermined standby position.

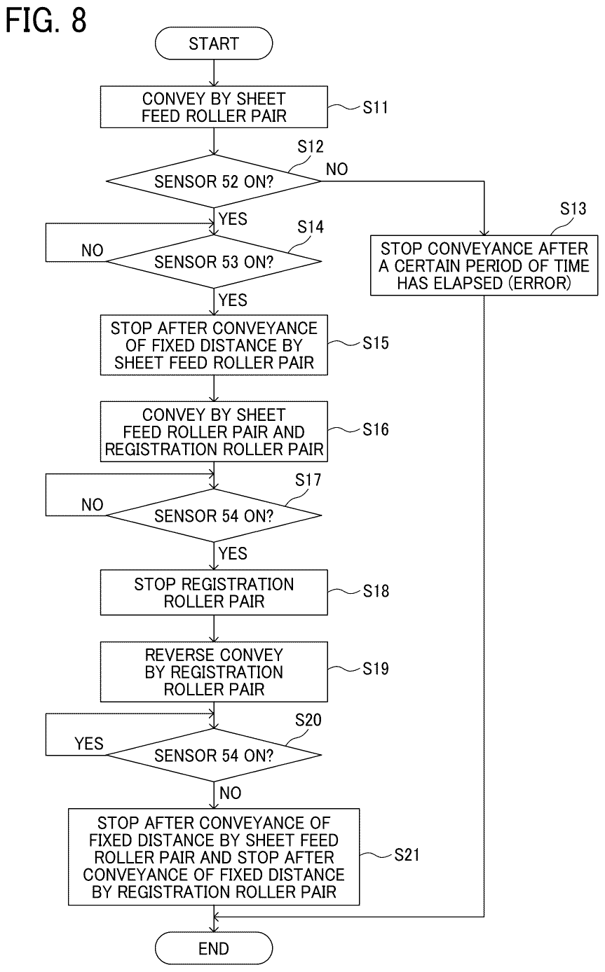

FIG. 8 is a flowchart of a process for conveying a rolled sheet 30 located at the standby position and correcting the curl C1 of the rolled sheet 30.

In step S11, upon receiving a predetermined conveyance start instruction, the controller 50 drives the drive motor 43 to cause the sheet feed roller pair 41 to convey the rolled sheet 30 positioned at the standby position in the forward direction.

As a result, the leading end of the rolled sheet 30 passes through the detection region of the downstream sensor 52, the downstream sensor 52 turns ON (Yes in S12). In response to a determination that the sensor 52 downstream of the sheet feed roller pair does not turn ON even after a fixed period has elapsed from the start of driving of the drive motor 43 (No in S12), the controller 50 stops the drive motor 43 to stop conveyance and performs error processing (S13).

After the downstream sensor 52 turns ON, conveyance by the sheet feed roller pair 41 continues. In response to the leading edge of the rolled sheet 30 passing through the detection region of the upstream sensor 53, the upstream sensor 53 turns ON (Yes in S14).

In step S15, upon receiving an ON signal from the upstream sensor 53, the controller 50 causes the sheet feed roller pair 41 to convey the rolled sheet 30 in the forward direction by a fixed distance, and then stops the drive motor 43. As a result, the conveyance of the rolled sheet 30 is stopped with its leading end contacting the nip region between the registration roller pair 42.

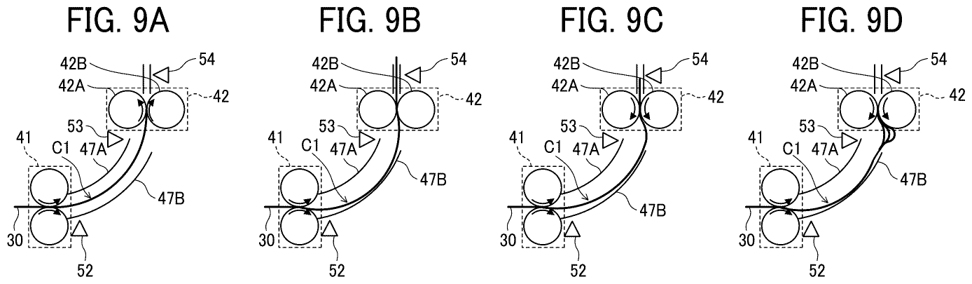

In step S16, the controller 50 drives the drive motors 43 and 44 to cause the sheet feed roller pair 41 and the registration roller pair 42 to convey the rolled sheet 30 in the forward direction as illustrated in FIG. 9A. As a result, the leading end of the rolled sheet 30 passes through the nip region of the registration roller pair 42 and further passes through the detection region of the downstream sensor 54 of the registration roller pair. As a result, when the downstream sensor 54 turns on (Yes in S17), in step S18, the controller 50 stops the drive motor 44 to stop the conveyance by the registration roller pair 42. At this time, since the conveyance by the sheet feed roller pair 41 continues, slack occurs in a portion of the rolled sheet 30 located between the sheet feed roller pair 41 and the registration roller pair 42 as illustrated in FIG. 9B.

In step S19, the controller 50 drives the drive motor 44 in reverse rotation to cause the registration roller pair 42 to convey the rolled sheet 30 in the reverse direction. As a result, as illustrated in FIGS. 9C and 9D, the leading end of the rolled sheet 30 that has passed through the nip region of the registration roller pair 42 is returned to the nip region of the registration roller pair 42, while slack in the portion of the rolled sheet located between the sheet feed roller pair 41 and the registration roller pair 42 further increases.

As the slack in this portion of the rolled sheet increases, the slack portion is brought into a curl-correction state, as illustrated in FIG. 9D, in which the slack portion is pressed, from the nip region of the registration roller pair 42, against and along the curved surface (outer circumferential surface) of the outer roller 42B, which is one of the rollers of the registration roller pair 42.

When the leading end of the rolled sheet 30 passes, in the reverse direction, through the detection region of the downstream sensor 54 and the downstream sensor 54 turns OFF (No in S20), in step S21, the controller 50 causes the sheet feed roller pair 41 to convey the rolled sheet 30 in the forward direction by a fixed distance and then stops the drive motor 43, and causes the registration roller pair 42 to convey the rolled sheet 30 in the reverse direction by a fixed distance and then stops the drive motor 44 (S21). As a result, the curl-correction state is maintained, and a curl C2 having a curl direction opposite to that of the curl C1 can be imparted to the leading end of the rolled sheet 30, and the curl C1 at the leading end of the rolled sheet 30 can be corrected.

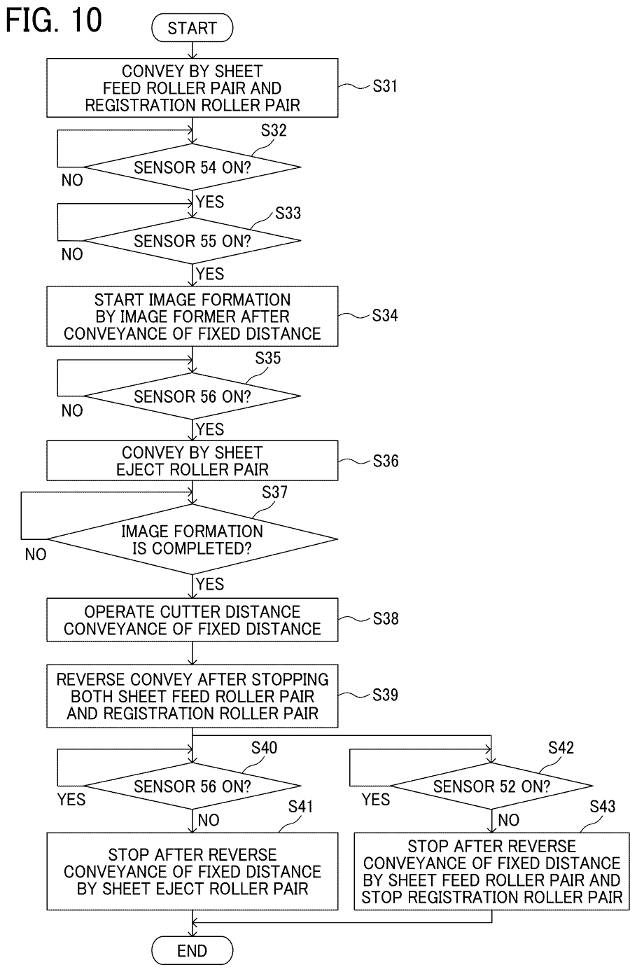

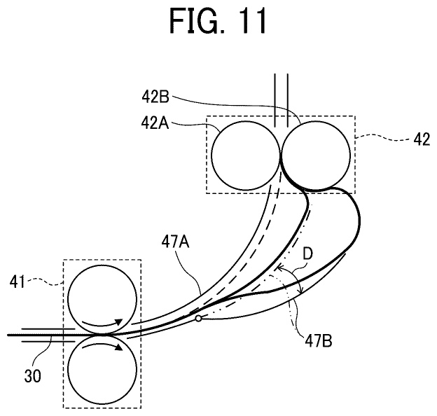

FIG. 10 is a flowchart of a process for forming an image on a rolled sheet 30 with an image former 2 and ejecting the sheet.

In step S31, in response to receiving a predetermined image formation start instruction, the controller 50 drives the drive motors 43 and 44 to cause the sheet feed roller pair 41 and the registration roller pair 42 to convey the rolled sheet 30 in the forward direction. As a result, a region of the rolled sheet 30 for image recording is conveyed toward the image former 2. At this time, when the sheet feed roller pair 41 and the registration roller pair 42 convey the rolled sheet 30 by the same amount, the curl-correction state is also maintained in the portion of the rolled sheet 30 following the leading end portion. That is, the portion of the rolled sheet 30 following the leading end is conveyed in a state (curl-correction state) in which the portion is pressed, with the nip region of the registration roller pair 42 as a starting point, along and against the curved surface (outer circumferential surface) of the outer roller 42B of the registration roller pair 42. In this manner, by being conveyed in the curl-correction state, the portion of the rolled sheet 30 following the leading end is also imparted with a curl C2 having a curl direction opposite to that of the curl C1 set in the rolled sheet 30, and the curl C1 is corrected.

Once the sheet feed roller pair 41 and the registration roller pair 42 start conveying the sheet, the leading end of the roll sheet 30 passes through the detection area of the downstream sensor 54, causing the sensor to output an ON signal (Yes in step S32). As the rolled sheet 30 is conveyed further, the leading end of the sheet passes through the detection area of the image-former sensor 55, which is located upstream of the image former 2 in the conveyance direction, causing the image-former sensor 55 to turn ON (Yes in step S33). In step S34, in response to receiving an ON signal from the image-former sensor 55, the controller 50 causes the sheet feed roller pair 41 and the registration roller pair 42 to convey the rolled sheet 30 in the forward direction by a fixed distance, then stops the drive motors 43 and 44 and starts an image forming operation by the image former 2.

In the image forming operation by the image former 2, the sheet feed roller pair 41 and the registration roller pair 42 intermittently convey the rolled sheet 30 in the forward direction, and the recording head 15a repeatedly discharges ink droplets to form a desired image corresponding to image information on the rolled sheet 30.

During the image forming operation, when the leading end of the rolled sheet 30 reaches the detection area of the sheet-eject sensor 56 (Yes in S35), in step S36, the controller 50 controls the ejection roller pair 45 in the same manner as the sheet feed roller pair 41 and the registration roller pair 42 to intermittently convey the rolled sheet 30.

Then, in step S38, once the image-forming operation by the image former 2 has been completed (Yes in S37) and the rolled sheet 30 has subsequently been conveyed in the forward direction by a fixed distance by the sheet feed roller pair 41, the registration roller pair 42, and the ejection roller pair 45, the controller 50 causes the sheet cutter 5 to cut a portion of the rolled sheet 30 located downstream of an image recording region in the conveyance direction. The image recording region of the rolled sheet 30 refers to a region in which an image has been formed. In step S41, when the trailing end of the cut sheet, which includes the image recording region of the rolled sheet 30, passes through the detection area of the sheet-eject sensor 56 and the sheet-eject sensor 56 turns OFF (No in step S40), the controller 50 causes the ejection roller pair 45 to convey the cut sheet in the forward direction by a fixed distance and then stops the drive motor 46. As a result, the cut sheet, which includes the image recording region of the rolled sheet 30, is conveyed by the ejection roller pair 45 and ejected onto the ejection tray.

In step S39, after the sheet cutter 5 cuts the rolled sheet 30, the controller 50 stops the conveyance by the registration roller pair 42 and the ejection roller pair 45, and then starts reverse conveyance to convey the remaining portion of the rolled sheet 30 in the reverse direction. In step S43, the controller 50 stops the drive motor 44 of the registration roller pair 42 when the leading end of the remaining rolled sheet 30 passes through the detection area of the downstream sensor 52 in the reverse direction and the downstream sensor 52 turns off (No in S42). Then, after the sheet feed roller pair 41 conveys the rolled sheet 30 in the reverse direction by a fixed distance, the controller 50 stops the drive motor 43. A a result, the leading end of the rolled sheet 30 can be positioned at a predetermined standby position.

In the present embodiment, when attempting to increase the wrap length or the wrap angle of the slack portion of the rolled sheet, an outer conveyance guide 47B, which contacts the surface of the rolled sheet on the convex side when the sheet slackens, may restrict the rolled sheet portion located between the sheet feed roller pair 41 and the registration roller pair 42, making it impossible to increase the wrap length or the wrap angle. In such a case, as illustrated by the arrow D in FIG. 11, it is preferable to configure the outer conveyance guide 47B to be displaceable in the direction toward or away from the surface of the rolled sheet portion.

As one example of this configuration, the outer conveyance guide 47B is a flexible member, and the outer conveyance guide 47B is pressed by the slack portion of the rolled sheet 30 and bends, and the outer conveyance guide 47B is displaced in a direction away from the surface of the rolled sheet portion. Accordingly, as the outer conveyance guide 47B is displaced in the direction away from the surface of the rolled sheet portion, the contact length (or wrap length) of the slack portion of the rolled sheet 30 can be increased or the wrap angle can be increased. In addition, allowing the slack portion of the rolled sheet to contact the outer conveyance guide 47B helps stabilize its orientation (and position).

As another example of the configuration, the outer conveyance guide 47B may be configured to be rotatable about a rotation shaft located at one end in the conveyance direction by a driving force of a drive device. In this case, the controller 50 can control the drive device to adjust the rotational position of the outer conveyance guide 47B, that is, its position in the direction toward of away from the surface of the rolled-sheet portion. Accordingly, for example, the position of the outer conveyance guide 47B can be appropriately adjusted in accordance with the type of the rolled sheet.

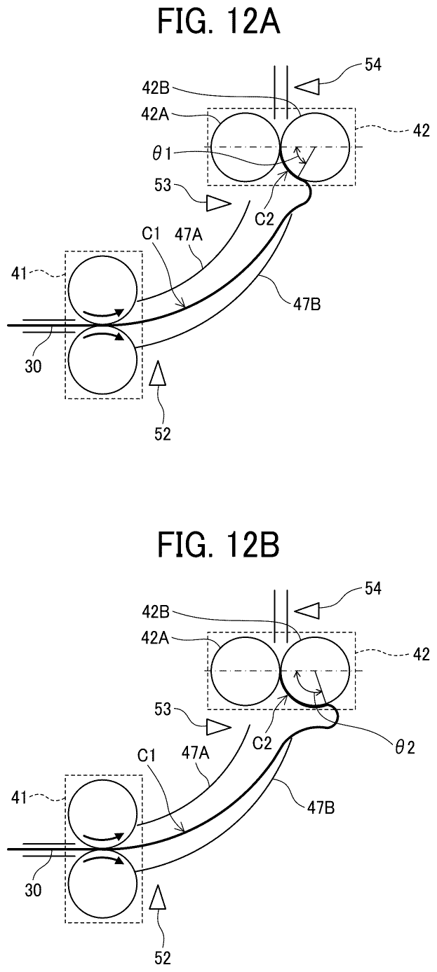

In the present embodiment, when conveyance by the registration roller pair 42 is stopped, or when the conveyance amount (conveyance speed) by the registration roller pair 42 is smaller than that by the sheet feed roller pair 41, conveyance by the sheet feed roller pair 41 slackens the portion of the rolled sheet located between the two roller pairs, thereby allowing the slack portion to be pressed, from the nip region of the registration roller pair 42, against and along the curved surface of the outer roller 42B. Accordingly, by appropriately adjusting the amount of conveyance by the registration roller pair 42 and the sheet feed roller pair 41, the controller 50 can adjust the wrap length, that is, the length over which the slack portion of the rolled sheet is pressed, from the nip region of the registration roller pair 42, against and along the curved surface of the outer roller 42B, as illustrated in FIG. 12A and 12B.

In other words, the wrap angle formed as the slack portion of the rolled sheet 30 extends from the nip region of the registration roller pair 42 along the curved surface of the outer roller 42B may be set to θ1 as illustrated in FIG. 12A, or θ2 as illustrated in FIG. 12B. Thus, by changing the contact length (wrap length) or the wrap angle of the slack portion of the rolled sheet 30, different curl correction states can be produced, and a curl correction state corresponding to a predetermined curl correction condition can be selected to perform curl correction processing.

In this case, when the outer conveyance guide 47B is configured to be displaceable in the direction toward or away from the surface of the rolled sheet portion between the sheet feed roller pair 41 and the registration roller pair 42, the controller 50 preferably also controls the position of the outer conveyance guide 47B in the direction toward or away from the surface when changing the wrap length or the wrap angle of the slack portion of the rolled sheet 30.

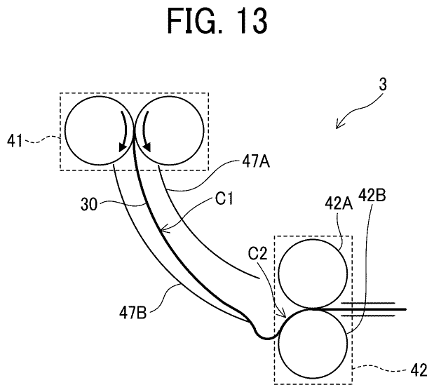

In the present embodiment, the positional relationship between the sheet feed roller pair 41 and the registration roller pair 42 may be configured as illustrated in FIG. 13. In the configuration illustrated in FIG. 13, the up-down direction in the drawing coincides with the vertical direction. In this case, when a portion of the rolled sheet 30 located between the sheet feed roller pair 41 and the registration roller pair 42 becomes slack, the slack portion of the rolled sheet 30 hangs down from a nip region of the registration roller pair 42 toward the outer roller 42B. As a result, the slack portion of the rolled sheet 30 is brought into a curl-correction state, with the slack portion of the rolled sheet 30 pressed against and along a curved surface of the outer roller 42B by its own weight. With this configuration, a portion of the rolled sheet 30 located between the sheet feed roller pair 41 and the registration roller pair 42 can be brought into a curl-corrected state in a stable manner.

The above-described embodiment is one example, and the following Aspects 1 to 5 of the present disclosure provide the advantages described below.

### Aspect 1

A conveying device includes a sheet feeder (e.g., a rolled-sheet storage 4), a conveyor (e.g., a sheet conveyor 3), and circuitry (e.g., a curl correction unit, a controller 50). The sheet feeder is used to load a sheet (e.g., a rolled sheet 30) rolled around a first curvature center (e.g., a curl C1). The conveyor conveys the sheet fed from the sheet feeder through a conveyance path in a conveyance direction. The conveyor includes a first roller pair (e.g., a sheet feed roller pair 41) disposed downstream of the sheet feeder in the conveyance direction to convey a sheet in the conveyance direction; and a second roller pair (e.g., a registration roller pair 42) disposed downstream of the first roller pair in the conveyance direction. The second roller pair includes a first roller (e.g., an inner roller 42A) and a second roller (42B) disposed opposite to the first roller via the conveyance path to form a nip to nip the sheet between the first roller and the second roller; and having a second curvature center (e.g., a curl C2) opposite to the first curvature center at the nip. The circuitry is configured to feed the sheet from the first roller pair to the second roller pair until the sheet passes the second roller pair; reversely feed the sheet from the second roller pair toward the first roller pair, to slack a leading end of the sheet toward the second roller of the second roller pair to form a slack portion in the leading end to correct a curl of the sheet.

In a typical conveying device, correction of curl of a sheet requires an operation of moving the sheet out of a sheet conveyance path and sending the sheet to a branch path, and then returning the sheet to the sheet conveyance path after curl correction. As a result, a curl-correction process for the sheet takes time, and it takes time until the sheet whose curl has been corrected is conveyed to a predetermined conveyance destination.

In this aspect, for example, a sheet portion between the first conveyor and the second conveyor can be slackened or deflected by applying a conveying force from the first conveyor while sheet conveyance is stopped at a nip region of the second conveyor (a pair of nipping members), or while the sheet passes through the nip region at a relatively low conveyance speed. Since one nipping member included in the second conveyor is a curved-surface member, the slack portion of the sheet can be brought into a curl-correction state in which, from the nip region of the second conveyor (the pair of nipping members), the slack portion is pressed against and along the curved surface of the curved-surface member included in the second conveyor. In this aspect, the sheet can be brought into a curl-correction state by pressing the sheet against the curved surface of the curved-surface member included in the second conveyor that constitutes a conveyor for conveying the sheet to a predetermined conveyance destination.

According to this aspect, a curl-correction process can be performed on the sheet present on the sheet conveyance path of the conveyor, and the typical operation in which the sheet is fed out of the sheet conveyance path to a branch path and then returned to the sheet conveyance path can be omitted. Moreover, in this aspect, the curl-correction state can be achieved by controlling the respective operations of the first conveyor and the second conveyor that constitute the conveyor, and a rapid curl-correction process is thereby enabled. According to this aspect, the time for correcting curl of the sheet can be shortened, and the time until the sheet having corrected curl is conveyed to the predetermined conveyance destination can also be shortened.

The circuitry is configured to control the first roller pair to rotate in a first direction at a first speed, while controlling the second roller pair to temporarily stop or rotate in the first direction at a second speed slower than the first speed, to form the slack portion in the leading end at the nip; and control the second roller pair to rotate in a second direction opposite to the first direction, to increase the slack portion in the leading end at the nip; and to press the slack portion against and along a curved surface of the second roller from the nip.

### Aspect 2

According to Aspect 2, in Aspect 1, the sheet feeder loads the sheet rolled around the first curvature center to have a first curved surface, and the circuitry presses the leading end of the sheet to the curved surface of the second roller having a second curved surface opposite the first curved surface.

With this configuration, curl set by the sheet being wound in a roll shape can be corrected in a shorter time. In particular, according to the configuration of Aspect 1, not only curl occurring at the leading end of the sheet but also curl occurring after the leading end of the sheet can be corrected. Furthermore, a curl-correctable range (e.g., a length in the sheet conveyance direction) is not limited to a particular length.

Accordingly, all curl occurring throughout the rolled sheet 30 can be corrected.

### Aspect 3

According to Aspect 3, in Aspect 1 or 2 the first roller of the second roller pair is disposed closer to the sheet feeder than the second roller with respect to the conveyance path; and the second roller of the second roller pair is disposed father from the sheet feeder than the first roller with respect to the conveyance paths.

With this configuration, curl of the sheet can be corrected by using a conveyor including a typical roller pair.

### Aspect 4

According to Aspect 4, in any one of Aspects 1 to 3, the conveying device further includes a guide defining the conveyance path between the first roller pair (41) and the second roller pair (42). The circuitry is further configured to control the first roller pair and the second roller pair to bring the sheet in contact with the guide to maintain the slack portion during conveyance of the sheet by the conveyor.

With this configuration, sheet conveyance can be performed while correcting curl of the sheet.

### Aspect 5

According to Aspect 5, in any one of Aspects 1 to 4, the first roller pair is disposed vertically above the second roller pair, and the second roller (42B) is disposed below the first roller (42A) via the nip at the second roller pair, to form the slack portion hanged downward from the nip under gravity and pressed against and along the curved surface of the second roller from the nip.

With this configuration, a sheet portion located between the first conveyor and the second conveyor can be stably brought into a curl-correction state.

### Aspect 6

According to Aspect 6, in any one of Aspects 1 to 5, the circuitry is further configured to control each operation of the first conveyor member and the second conveyor member, to change a wrap length over which the slack portion is pressed against the curved surface, from the nip region, along the curved surface, according to a predetermined curl correction condition.

With this configuration, different curl-correction states can be created, and the curl-correction process can be performed by selecting a curl-correction state that matches predetermined curl-correction conditions.

### Aspect 7

According to Aspect 7, in Aspect 6, the conveying device further includes a guide (e.g., an outer conveyance guide 47B) defining the conveyance path between the first roller pair (41) and the second roller pair (42). The guide displaces toward the second roller when the circuitry changes the length of the slack portion.

With this configuration, even when a length over which the sheet portion is pressed changes, the sheet portion located between the first conveyor and the second conveyor can be appropriately guided by the guide, and an orientation of the slackened sheet portion can be stabilized. Accordingly, the slackened sheet portion can be stably brought into a curl-correction state.

### Aspect 8

According to Aspect 7, in Aspect 6, the conveying device further includes a guide (e.g., an outer conveyance guide 47B) defining the conveyance path between the first roller pair (41) and the second roller pair (42). The guide is displaceable toward the second roller.

With this configuration, displacement of the guide in a direction away from the sheet surface makes it possible to increase a length over which the slackened sheet portion is wrapped. Further, with the slackened sheet portion in contact with the guide, an orientation of the slackened sheet portion is stabilized, and a curl-correction state can be stably maintained.

### Aspect 9

According to Aspect 9, an image forming apparatus (e.g., the inkjet recording apparatus 1) includes the conveying device (e.g., a sheet conveyor 3) according to any one of Aspects 1 to 8 to convey a sheet (e.g., a rolled sheet 30); and an image former (2) to form an image on the sheet conveyed by the conveying device (3).

According to this aspect, a time until the sheet whose curl has been corrected is conveyed to the image former 2 can be shortened.

### Aspect 10

A curl corrector includes a sheet feeder (e.g., a rolled-sheet storage 4), a conveyor (e.g., a sheet conveyor 3), and circuitry (e.g., a curl correction unit, a controller 50). The sheet feeder is used to load a sheet (e.g., a rolled sheet 30) rolled around a first curvature center (e.g., a curl C1). The conveyor conveys the sheet fed from the sheet feeder through a conveyance path in a conveyance direction. The conveyor includes a first roller pair (e.g., a sheet feed roller pair 41) disposed downstream of the sheet feeder in the conveyance direction to convey a sheet in the conveyance direction; and a second roller pair (e.g., a registration roller pair 42) disposed downstream of the first roller pair in the conveyance direction. The second roller pair includes a first roller (e.g., an inner roller 42A) and a second roller (42B) disposed opposite to the first roller via the conveyance path to form a nip to nip the sheet between the first roller and the second roller; and having a second curvature center (e.g., a curl C2) opposite to the first curvature center at the nip. The circuitry is configured to feed the sheet from the first roller pair to the second roller pair until the sheet passes the second roller pair; reversely feed the sheet from the second roller pair toward the first roller pair, to slack a leading end of the sheet toward the second roller of the second roller pair to form a slack portion in the leading end to correct a curl of the sheet.

According to this aspect, a time until the sheet whose curl has been corrected is conveyed to a predetermined conveyance destination can be shortened.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A conveying device comprising:
a sheet feeder to load a sheet rolled around a first curvature center;
a conveyor to convey the sheet fed from the sheet feeder through a conveyance path in a conveyance direction, the conveyor including:
a first roller pair disposed downstream of the sheet feeder in the conveyance direction to convey a sheet in the conveyance direction; and
a second roller pair disposed downstream of the first roller pair in the conveyance direction, the second roller pair including:
a first roller; and
a second roller disposed:
opposite to the first roller via the conveyance path to form a nip to nip the sheet between the first roller and the second roller; and
having a second curvature center opposite to the first curvature center at the nip; and
circuitry configured to:
feed the sheet from the first roller pair to the second roller pair until the sheet passes the second roller pair;
reversely feed the sheet from the second roller pair toward the first roller pair, to slack a leading end of the sheet toward the second roller of the second roller pair to form a slack portion in the leading end to correct a curl of the sheet.

2. The conveying device according to claim 1, wherein:
the circuitry configured to:
control the first roller pair to rotate in a first direction at a first speed, while controlling the second roller pair to:
temporarily stop; or
rotate in the first direction at a second speed slower than the first speed, to form the slack portion in the leading end at the nip; and
control the second roller pair to rotate in a second direction opposite to the first direction,
to increase the slack portion in the leading end at the nip; and
to press the slack portion against and along a curved surface of the second roller from the nip.

3. The conveying device according to claim 2, wherein:
the sheet feeder loads the sheet rolled around the first curvature center to have a first curved surface, and
the circuitry presses the leading end of the sheet to the curved surface of the second roller having a second curved surface opposite the first curved surface.

4. The conveying device according to claim 1, wherein:
the first roller of the second roller pair is disposed closer to the sheet feeder than the second roller with respect to the conveyance path; and
the second roller of the second roller pair is disposed farther from the sheet feeder than the first roller with respect to the conveyance path.

5. The conveying device according to claim 1, further comprising:
a guide defining the conveyance path between the first roller pair and the second roller pair, and
the circuitry is further configured:
control the first roller pair and the second roller pair to bring the sheet in contact with the guide to maintain the slack portion during conveyance of the sheet by the conveyor.

6. The conveying device according to claim 1, wherein:
the first roller pair is disposed vertically above the second roller pair, and
the second roller is disposed below the first roller via the nip at the second roller pair, to form the slack portion:
hanged downward from the nip under gravity; and
pressed against and along a curved surface of the second roller from the nip.

7. The conveying device according to claim 2, wherein:
the circuitry is further configured to:
control the first roller pair and the second roller pair to change a length of the slack portion pressed against the curved surface from the nip.

8. The conveying device according to claim 7, further comprising:
a guide defining the conveyance path between the first roller pair and the second roller pair,
wherein the guide displaces toward the second roller when the circuitry changes the length of the slack portion.

9. The conveying device according to claim 1, further comprising:
a guide defining the conveyance path between the first roller pair and the second roller pair,
wherein the guide is displaceable toward the second roller.

10. An image forming apparatus comprising:
the conveying device according to claim 1 to convey a sheet; and
an image former to form an image on the sheet conveyed by the conveying device.

11. A curl corrector comprising:
a sheet feeder to load a sheet rolled around a first curvature center;
a conveyor to convey the sheet fed from the sheet feeder through a conveyance path in a conveyance direction, the conveyor including:
a first roller pair disposed downstream of the sheet feeder in the conveyance direction to convey a sheet in the conveyance direction; and
a second roller pair disposed downstream of the first roller pair in the conveyance direction, the second roller pair including:
a first roller; and
a second roller disposed:
opposite to the first roller via the conveyance path to form a nip to nip the sheet between the first roller and the second roller; and
having a second curvature center opposite to the first curvature center at the nip; and
circuitry configured to:
feed the sheet from the first roller pair to the second roller pair until the sheet passes the second roller pair; and
reversely feed the sheet from the second roller pair toward the first roller pair, to slack a leading end of the sheet toward the second roller of the second roller pair to form a slack portion in the leading end to correct a curl of the sheet.
